(19) United States
(12) Patent Application Publication
(10) Pub. No.: US 2025/0175242 A1
(43) Pub. Date: May 29, 2025

(54) CONFIGURATION OF PERIODIC BEHAVIOR OF SPATIAL FILTER IN REPEATER-ASSISTED NETWORKS

(71) Applicant: Telefonaktiebolaget LM Ericsson (publ), Stockholm (SE)

(72) Inventors: Lei Bao, Göteborg (SE); Andreas Nilsson, Göteborg (SE); Magnus Åström, Lund (SE); Boris Dortschy, Vendelsö (SE); Behrooz Makki, Pixbo (SE)

(21) Appl. No.: 18/859,595

(22) PCT Filed: Apr. 26, 2023
(86) PCT No.: PCT/EP2023/061022

§ 371 Date: Oct. 24, 2024

Related U.S. Application Data
(60) Provisional application No. 63/334,885, filed on Apr. 26, 2022.

(51) Int. Cl. H04B 7/155; H04W 72/044; H04W 72/231

(52) U.S. Cl. CPC H04B 7/15557; H04W 72/044; H04W 72/231

(57) ABSTRACT

A method performed by a network node in a wireless network is provided for configuring periodic behavior of a repeater beam of a repeater node. The method comprises indicating, to the repeater node, a beam to use and indicating, to the repeater node, a beam time-domain state associated with the indicated beam. There is further provided a method in a repeater node. The method comprises receiving an indication, from the network node, of a beam to use and receiving an indication, from the network node, of a beam time-domain state associated with the indicated beam.

### TECHNICAL FIELD

The disclosure relates to a method performed by a network node in a wireless network, a method performed by a repeater node in a wireless network and a method performed in a wireless network comprising a network node and a repeater node. The method also relates to a network node, a repeater node and a system comprising a network node and a repeater node.

### BACKGROUND

### 1 Network Controlled Repeater

To increase the data rate and support the increasing number of UEs, different methods are considered, among which network densification and millimeter wave (mmW) communications are the dominant ones. Network densification refers to the deployment of multiple access points of different types in, e.g., metropolitan areas. Particularly, it is expected that in future small nodes, such as relays, Integrated Access and Backhaul (IAB) nodes, repeaters, etc., will be densely deployed to support existing macro base stations (BSs) serving User Equipments (UEs).

During the Third Generation Partnership Project (3GPP) Release 16 and Release 17, IAB has been well studied as the main relaying technique in Fifth Generation (5G), and the discussions will continue in Release 18 on Mobile IAB. Here, using a decode-and-forward relaying technique, the IAB node(s) can well extend the coverage and/or increase the throughput. However, an IAB node(s) may be a relatively complex and expensive node and thereby, depending on the deployment, alternative nodes with low complexity/cost for, e.g., blind spot removal, may be needed. Here, a candidate type of network node is a radio frequency (RF) repeater, which simply amplifies-and-forwards any signal that it receives. RF repeaters have been considered in 2G, 3G, and 4G to supplement the coverage provided by regular full-stack cells. However, an RF repeater lacks in, e.g., accurate beamforming which may limit its efficiency in, for instance, Frequency Range 2 (FR2).

With this background, a new study-item has been considered in 3GPP Release 18, to start in early 2022, in which the potentials and the challenges of network-controlled repeaters (NCR) will be evaluated (see RP-213700, “New SID on NR Smart Repeaters,” 3GPP TSG RAN Meeting #94e, Dec. 6-17, 2021). The scope and the features of network-controlled repeater are still under discussion. FIG. 1 gives an example of an NCR node deployment where the wireless connection between the NCR node and the NR base station (gNB) is referred to as a service link, whereas the wireless connection between the NCR node and the UE is referred to as an access link. Note that this terminology is only an example. As another example, the wireless connection between the NCR node and the gNB is referred to as a donor link, whereas the wireless connection between the NCR node and the UE is referred to as a service link.

In one alternative, an NCR can be a normal repeater with beamforming capabilities. In this way, the NCR node should be considered as a network-controlled “beam bender” relative the gNB. As such, it is logically part of the gNB for all management purposes, i.e., it is likely that the NCR is deployed and under the control of the operator. The NCR is based on amplify-and-forward relaying scheme, and it is likely to be limited to single-hop communication in stationary deployments with the focus on FR2. Finally, the scope of the Release 18 study-item is expected to be strictly on studying the physical layer (PHY) control signaling and mechanism and, consequently, the study-item will be carried out mainly by RAN1.

In particular, the NCR SID (RP-213700) considers the following focus for the study-item:
Network-controlled repeaters are inband RF repeaters used for extension of network coverage on FR1 and FR2 bands, while during the study FR2 deployments may be prioritized for both outdoor and outdoor-to-indoor (O2I) scenarios.
For only single hop stationary network-controlled repeaters
Network-controlled repeaters are transparent to UEs
Network-controlled repeater can maintain the gNB-repeater link and repeater-UE link simultaneously.

Also, the study-item will concentrate on identifying which side control information is required regarding:
Beamforming information
Timing information to align transmission/reception boundaries of network-controlled repeater
Information on uplink (UL)-downlink (DL) Time Division Duplexing (TDD) configuration
Power control information for efficient interference management
ON-OFF information for efficient interference management and improved energy efficiency.

How a network-controlled repeater will be designed and how it will communicate with the network is still not clear. FIG. 2 illustrates one schematic example of a network-controlled repeater. Note that this is an estimation of the possible network-controlled repeater structure, while the exact structure is still to be decided. In this example, the network-controlled repeater consists of three principal building blocks, the Modem, the Controller module, and the Repeater module section (depicted as the two amplifiers in FIG. 2). The network-controlled repeater is equipped with an antenna configuration, where a signal is first received in downlink (or uplink), and, e.g., after power amplification, transmitted further in downlink (or uplink). Since the Repeater module only amplifies and (analogously) beamforms the signal, no advanced receiver or transmitter chains are required, which reduce the cost and energy consumption compared to for example a normal Transmission and Reception Point (TRP). In its simplest architecture, different antenna modules are used for the service and access sides, i.e., the antennas targeting the gNB and UEs, respectively, whereas a more complex architecture, including self-interference cancellation, would allow for using the same antenna modules for both sides.

The Modem module is able and used to exchange control and status signaling with a gNB that is controlling the network-controlled repeater. For this, the Modem module supports at least a sub-set of UE functions. Network-controlled repeater control and status information is further exchanged between the Modem module and the Controller module. The Modem module might be equipped with antennae separated from the antennae used by the Repeater module; but in most configurations, the Modem module and Repeater module will share antenna configurations.

The Controller module is used to control the Repeater module, by for example providing beamforming information, power control information etc. The Controller module is connected to the network through the Modem module such that the network can control the Controller module and, in that way, control the Repeater module.

The Repeater module's amplify-and-forward operation is controlled by the Controller module. The Controller module could also be directly responsible for the beamforming control on the service antenna side, i.e., to/from served UEs. In an alternative, the beamforming on the service antenna side is operated by the Repeater module under control of the Controller module. On the access antenna side, i.e., to/from the controlling gNB, the Modem module could be directly responsible for the beamforming control. In an alternative, the beamforming on the access antenna side is operated by the Repeater module under control of the Controller module and/or Modem module.

In one configuration, the Modem module and the Repeater module do not only share an antenna configuration but also parts of the (analog) transmitter and/or receiver, such as power (transmit) amplifier and/or receiver amplifiers and/or filters.

The Modem module and the Repeater module could be operating at the same or different frequencies. For example, the Repeater module could operate at a high frequency band (FR2) and the Modem module could be operating at a low frequency band (FR1)

### 2 Intelligent Reflecting Surface

Intelligent Reflecting Surface (IRS), also known as Reconfigurable Intelligent Surface (RIS), is an emerging technology that is capable of intelligently manipulating the propagation of electro-magnetic waves. RIS is composed of a 2-dimensional array of reflecting elements, where each element acts as a passive reconfigurable scatterer, i.e., a piece of manufactured material, which can be programmed to change an impinging electro-magnetic wave in a customizable way. Such elements are usually low-cost passive surfaces that do not require dedicated power sources, and the radio waves impinged upon them can be forwarded without the need of employing power amplifier or RF chain. Moreover, RIS can, potentially, work in full duplex mode without significant self-interference or increased noise level and requires only low-rate control link or backhaul connections. RIS can be flexibly deployed due to its low weight and low power consumption. Specially, RIS is of interest in stationary or low-mobility networks, in which the transmission parameters can be well planned and, e.g., blockages/tree foliage is bypassed through RIS-assisted communication.

There are still ambiguities about the detailed differences of the network-controlled repeaters and RISs. A simple explanation is that a RIS is a network-controlled repeater with no or negative amplification. In general, an RIS is expected to be a simpler and cheaper node with less focused beamforming capability/accuracy and without active amplification. That is, RIS may be capable of signal reflection via adapting a phase matrix while the network-controlled repeater is capable of advanced beamforming with power amplification. In 3GPP, RIS-assisted communication was initially suggested as a possible technology to be considered in Release 18 study-item on network-controlled repeater. For instance, RIS has been discussed in 3GPP TSG RAN Rel-18 workshop, June 2021 (see, e.g., RP-213700, “New SID on NR Smart Repeaters,” 3GPP TSG RAN Meeting #94e, Dec. 6-17, 2021 and RWS-210300, “NR repeaters and Reconfigurable Intelligent Surface”, 3GPP TSG RAN Rel-18 workshop, June 2021). However, it was decided not to include the RIS in the study-item and leave it for possible discussions in next 3GPP releases. Then, while specification wise a network-controlled repeater is likely to be a superset of the RIS, it is not unlikely that RIS-specific features are discussed in the Release 18 study-item on network-controlled repeaters.

A RIS might have a similar design as the network-controlled repeater exemplified in FIG. 1, but without the signal amplification step in the Repeater module.

### 3 NR Multi-Beam Operation

### 3.1 Beam Management Procedure

In high frequency range (FR2), multiple RF beams may be used to transmit and receive signals at a gNB and a UE. For each DL beam from a gNB, there is typically an associated best UE receive (Rx) beam for receiving signals from the DL beam. The DL beam and the associated UE Rx beam form a “beam pair”. The beam pair can be identified through a so-called beam management process in NR.

A DL beam is (typically) identified by an associated DL reference signal (RS) transmitted in the beam, either periodically, semi-persistently, or aperiodically. The DL RS for this purpose can be a Synchronization Signal (SS) and Physical Broadcast Channel (PBCH) block (SSB) or a Channel State Information RS (CSI-RS). By measuring all the DL RSs, the UE can determine and report to the gNB the best DL beam to use for DL transmissions. The gNB can then transmit a burst of different DL-RSs in the reported best DL beam to let the UE evaluate candidate UE RX beams.

Although not explicitly stated in the NR specification, beam management has been divided into three procedures, schematically illustrated in FIG. 3:
P-1: Purpose is to find a coarse direction for the UE using wide gNB TX beam covering the whole angular sector
P-2: Purpose is to refine the gNB TX beam by doing a new beam search around the coarse direction found in P-1.
P-3: Used for UE that has analog beamforming to let them find a suitable UE RX beam.
P-1 is expected to utilize beams with rather large beamwidths and where the beam reference signals are transmitted periodically and are shared between all UEs of the cell. Typically reference signal to use for P-1 are periodic CSI-RS or SSB. The UE then reports the N best beams to the gNB and their corresponding RSRP values.
P-2 is expected to use aperiodic/or semi-persistent CSI-RS transmitted in narrow beams around the coarse direction found in P-1.
P-3 is expected to use aperiodic/or semi-persistent CSI-RSs repeatedly transmitted in one narrow gNB beam. One alternative way is to let the UE determine a suitable UE RX beam based on the periodic SSB transmission. Since each SSB consists of four OFDM symbols, a maximum of four UE RX beams can be evaluated during each SSB burst transmission. One benefit with using SSB instead of CSI-RS is that no extra overhead of CSI-RS transmission is needed.

### 3.2 Beam Indication

In NR, several signals can be transmitted from different antenna ports of a same base station. These signals can be received with the similar large-scale properties such as Doppler shift/spread, average delay spread, or average delay on different antenna ports. These receive antenna ports are then said to be quasi co-located (QCL).

If the UE knows that two of its antenna ports are QCL with respect to a certain parameter (e.g., Doppler spread), the UE can estimate that parameter based on one of the antenna ports and apply that estimate for receiving signal on the other antenna port.

For example, there may be a QCL relation between a CSI-RS for tracking RS (TRS) and the Physical Downlink Shared Channel (PDSCH) Demodulation Reference Signal (DMRS). When UE receives the PDSCH DMRS, the UE can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced in NR to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its RX beam in some direction prior to receiving a certain signal. If the UE knows that the signal is spatially QCL with some other signal it has received earlier, then it can safely use the same RX beam to also receive this signal.

In NR, the spatial QCL relation for a DL or UL signal/channel can be indicated to the UE by using a “beam indication”. The “beam indication” is used to help the UE to find a suitable RX beam for DL reception, and/or a suitable TX beam for UL transmission. In NR, the “beam indication” for DL is conveyed to the UE by indicating a transmission configuration indicator (TCI) state to the UE, while in UL the “beam indication” can be conveyed by indicating a DL-RS or UL-RS as spatial relation (in NR Rel-15/16) or a TCI state (in NR Rel-17).

### 4 Beam Expansion

By utilizing antenna elements with different polarizations, it is possible to define fewer beam weights or shorter precoders, corresponding to a beam with fewer antenna elements, to expand, e.g., by using a cross-polarized Uniform Linear Array (ULA) antenna, into more (e.g., times 2 below) elements, while maintaining the (wider) beam shape of the shorter array size, thereby expanding the beam from the fundamental phased array (Fast Fourier Transform (FFT)) beam. In other words, it is possible to define beams that are shaped as if the antenna would have fewer elements while they maintain the output power of phased array beams of the full antenna array size. It should be noted that it is the aggregated beam shape from both polarizations that is expanded, the beams from each polarization direction will have a different shape.

Consider a cross-polarized ULA with M cross-pole antennas, the two polarizations excited with a pair of weights or precoders, {W_{A,1}, W_{B,1}}, so that it produces some desired total power-radiation pattern, hereafter referred to as a proto-array (see, e.g., “Efficient Cell-Specific Beamforming for Large Antenna Arrays”, M. A. Girnyk, S. O. Petersson, IEEE Transactions on Communications, Volume: 69 Issue: 12, pp. 8429-8442 December 2021). The basic underlying principle of designing broad beams is the creation of beams with equal total radiation patterns, but with orthogonal polarization in different angular directions.

One could use a pair {W_{A,2}, W_{B,2}} to excite another M-antenna array, referred to as a companion array hereafter. Since the electric fields produced by the two sets of weights are orthogonal, the total radiation patterns of the two arrays would add incoherently at two orthogonally polarized receiver antennas without affecting each other. Hence, if the two arrays are attached into a larger, expanded array, the latter will preserve the total radiation pattern of its subarrays (same for both the proto-array and its companion array). The weights of the expanded array can be obtained as

$${w}_{A} = {[ {w}_{A , 1}^{T} , {w}_{A , 2}^{T} ]}^{T} , \\ {w}_{B} = {[ {w}_{B , 1}^{T} , {w}_{B , 2}^{T} ]}^{T} , \\ where \\ {w}_{A , 2} = - κ {\overleftrightarrow{{w}_{B , 1}}}^{*} \\ {w}_{B , 2} = - κ {\overleftrightarrow{{w}_{A , 1}}}^{*}$$

where κ is an arbitrary complex multiplier with unit norm, and \vec{w} is the operator of flipping the elements of a vector w and * is the complex conjugate.

### SUMMARY

There currently exist certain challenge(s). As described in Section 3, in NR, the beam indication is used to help the UE to find a suitable RX beam for DL reception and/or a suitable TX beam for UL transmission. The beam indication for DL is conveyed to the UE by indicating a transmission configuration indicator (TCI) state to the UE, while in UL the beam indication can be conveyed by indicating a DL-RS or UL-RS as spatial relation (in NR Rel-15/16) or a TCI state (in NR Rel-17). The beam mapping between a UL/DL beam index and a DL-RS or UL-RS in a TCI state is left to the implementation of the gNB and UE. In other words, the gNB and the UE do not need to know about the beam arrangement at the other side. In case of, e.g., a network-controlled repeater, since the repeater nodes are controlled by the gNB, the gNB will need to know about all the repeater beams and geometrical relations between them, e.g., through repeater beam indices. Regarding how to control the repeater beam switching during operation, the Controller module and Repeater module may know about the semi-static TDD pattern (e.g., from SIB1), i.e., slots and symbols used for different signals/channel, but it does not know, and will not need to know, the instantaneous UE scheduling, for example
If there is any UE scheduled for PDSCH/PUSCH/PUCCH/ . . . .
Which UE is scheduled for PDSCH/PUSCH/PUCCH/ . . . .
If a repeater beam switching will take place when one type of signals/channels is changed to another type of signals/channels, or different UEs are served in consecutive PDSCH slots etc.

FIG. 4 gives an example to illustrate time domain operations at the gNB and repeater node, with respect to different signals/channels (PDCCH/PDSCH/PUSCH/PUCCH/SSB/PRACH), over ten consecutive slots (SL), when serving UE1 and UE2, respectively. For example, in SL0, the cell common PDCCH is broadcasted to the repeater node and both UE1 and UE2; whilst the PDSCH is scheduled to the repeater node, UE1, and UE2 in SL0, SL1, and SL3, respectively. The diagonal line indicates the time resource is not used in communication e.g., between gNB and repeater node, or between the repeater node and UE1 etc. The diagonal striped pattern (in the last row) represents the time resource the Repeater module is in use, i.e., where a repeater beam switching (on the access link) may take place.

The applicant has appreciated that in order to minimize the impact to the UE due to the existence of a repeater node, it would be desirable to develop overhead efficient signaling which can be used by the gNB to control repeater beam switching with high accuracy and low latency.

Certain aspects of the disclosure and their embodiments may provide solutions to these or other challenges.

The present invention is defined in the appended claims to which reference is now directed.

According to the present invention there is provided a method performed by a network node in a wireless network for configuring periodic behavior of a spatial filter of a repeater node. The method comprises indicating, to the repeater node, a beam to use. The method further comprises indicating, to the repeater node, a beam time-domain state associated with the indicated beam.

Indicating, to the repeater node, the beam to use may comprise indicating the beam using Beam index/ID.

The indication of the beam to use may be conveyed to the repeater node in Radio Resource Control, RRC, signaling and/or Medium Access Control Control Element, MAC CE, signaling.

The beam time-domain state may comprise: starting Orthogonal Frequency Division Multiplexing, OFDM, symbol in a slot, duration in number of OFDM symbols, slot number and/or slot periodicity.

The indication of the beam time-domain state associated with the indicated beam may be conveyed in RRC signaling.

In an embodiment, the beam time-domain state is RRC configured in the repeater node as an RRC information element.

In an embodiment, the beam time-domain state is associated with a periodicity. The beam time-domain state may be semi-static.

In an embodiment, the beam to use and the beam time-domain state associated with the beam to use are configured jointly by the network node.

The method may comprise indicating, to the repeater node, a plurality of beams to use and indicating, to the repeater node, a plurality of associated beam time-domain states. Each beam time-domain state may be associated with a respective one of the plurality of beams to use.

In an embodiment, indicating, to the repeater node, a beam to use comprises indicating, to the repeater node, a beam to use from among a set of repeater beams.

The method may comprise indicating, to the repeater node, a beam to use and/or an a beam time-domain state associated with the indicated beam based on repeater beam information.

The method may further comprise receiving a repeater beam arrangement report from a repeater node.

The repeater node may be a network-controlled repeater or a RIS.

There is also provided a method performed by a repeater node in a wireless network for configuring periodic behavior of a repeater beam of the repeater node. The method comprises receiving an indication, from a network node, of a beam to use. The method further comprises receiving an indication, from the network node, of a beam time-domain state associated with the indicated beam.

There is further provided a method in a wireless network for configuring periodic behavior of a repeater beam of a repeater node. The method comprises a network node indicating, to the repeater node, a beam to use and the network node indicating, to the repeater node, a beam time-domain state associated with the indicated beam. The method further comprises the repeater node receiving the indication, from the network node, of a beam to use and the repeater node receiving the indication, from the network node, of a beam time-domain state associated with the indicated beam.

There is also provided a network node for configuring periodic behavior of a repeater beam of a repeater node. The network node comprises processing circuitry configured to indicate, to the repeater node, a beam to use and to indicate, to the repeater node, a beam time-domain state associated with the indicated beam.

There is also provided a repeater node configured to receive an indication, from a network node, of a beam to use and receive an indication, from the network node, of a beam time-domain state associated with the indicated beam.

There is further provided a system comprising the above-described network node and repeater node.

There is further provided a computer program or computer program product or carrier comprising a computer program, the computer program comprising instructions which, when executed on a processor circuitry cause the processor circuitry to perform any of the above methods.

Advantageously, embodiments enable a network node such as a gNB to configure periodic behavior of spatial filter configurations of a repeater node and thereby facilitate control of the repeater node beams by the network node. In some embodiments, the proposed method does not require the repeater node to have an understanding of the signals/channels, such as PDCCH, PUCCH, PDSCH, PUSCH, SSB, PRACH etc. Furthermore, embodiments may advantageously reduce the usage of dynamic signaling and improve signaling efficiency.

Facilitating beamforming is one of the main objectives of the 3GPP Rel-18 study item on network-controlled repeaters. Particularly, embodiments of the proposed solution may enable the integration of network-controlled repeaters/RISs into the network and improve coverage extension. In this way, the network-controlled repeater/RIS helps to efficiently, e.g., bypass blockages, and avoid performance drop (beam link failure) of the UEs. It furthermore enables efficient use of a repeater node since it allows for a wider coverage of broadcast beams, resulting in less overhead, at the same time as more narrow unicast beams are enabled, resulting in higher throughput.

### DESCRIPTION OF THE FIGURES

Some of the embodiments contemplated herein will now be described more fully with reference to the accompanying drawings. Embodiments are provided by way of example to convey the scope of the subject matter to those skilled in the art.

FIG. 1 shows an example NCR node deployment;

FIG. 2 illustrates one schematic example of a network-controlled repeater;

FIG. 3 illustrates three beam management procedures;

FIG. 4 shows an example of time domain operations at the gNB and repeater node, with respect to different signals/channels;

FIG. 5 illustrates one example embodiment of a repeater-assisted network;

FIG. 6 is a flow chart showing a method in a network node according to an embodiment;

FIG. 7 is a flow chart showing a method in a repeater node according to an embodiment;

FIG. 8 is flow chart showing a method in a network comprising a network node and a repeater node according to an embodiment;

FIG. 9 is a flow chart that illustrates the operation of the gNB in an example;

FIG. 10 shows an example beam arrangement report;

FIG. 11 shows an example set of repeater beams to use;

FIG. 12(a) and FIG. 12(b) show one example to illustrate gNB and repeater node operations with respect to signals/channels in 10 slots, and the configured beam indication and beam time-domain state;

FIG. 13 illustrates an example joint indication of beam time-domain state and repeater beam and/or repeater state indication;

FIG. 14 shows an example of a communications system;

FIG. 15 shows a UE;

FIG. 16 shows a network node in accordance with some embodiments;

FIG. 17 shows a repeater node in accordance with some embodiments;

FIG. 18 shows a system comprising a network node and a repeater node in accordance with some embodiments;

FIG. 19 is a block diagram of a host;

FIG. 20 is a block diagram illustrating a virtualization environment in which functions may be implemented;

FIG. 21 shows a communication diagram of a host communicating via a network node with a UE over a partially wireless connection;

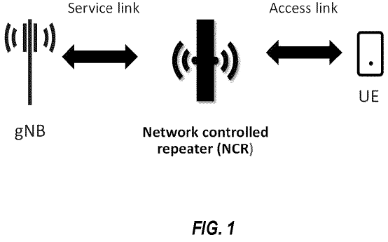

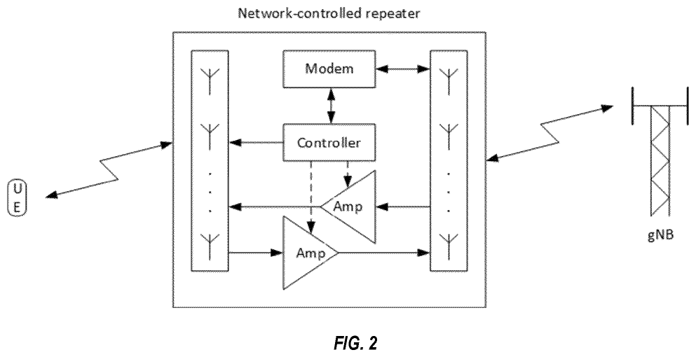

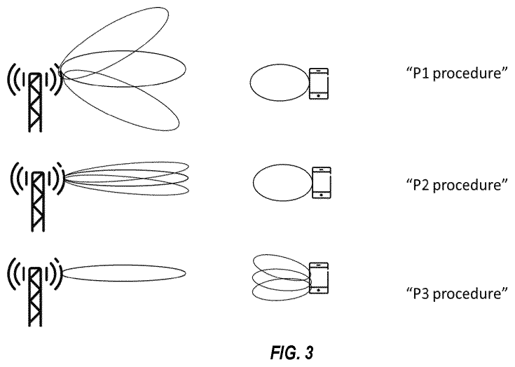

### DETAILED DESCRIPTION

In the present disclosure, the terminology “repeater node” refers to a network-controlled repeater or a reconfigurable intelligent surface, RIS, or nodes with similar types of functionalities, i.e., receiving a signal and instantaneously forwarding it in another direction, unless otherwise stated.

In the present disclosure, the terminology “repeater spatial filters” refers to repeater node beams, or precoders.

Systems and methods are disclosed herein for enabling a network node (e.g., a base station such as, e.g., a gNB or a network node that implements part of the functionality of a base station such as, e.g., a gNB-CU or gNB-DU) to efficiently control beam switching of a set of specific signals/channels at a repeater node, using, e.g., repeater beam indices, based on the reported repeater beam relations at the repeater node. This addresses one of the main objectives of the Rel-18 study-item on network-controlled repeaters regarding the control of repeater beamform functionality.

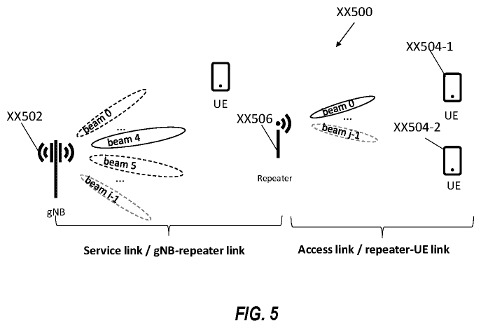

FIG. 5 illustrates one example embodiment of repeater-assisted network 500 in which embodiments of the present disclosure may be implemented. As depicted in FIG. 5, the repeater-assisted network 500 includes a source node (e.g., a gNB 502 in the illustrated example) communicating with one or more destination nodes (e.g., UEs 504-1 and 504-2 in the illustrated example) in wireless communication links that are relayed by a repeater node 506 (e.g., network-controlled repeater or intelligent surface etc.). The appendix, in the form of a standards contribution, discusses terminology for NW-controlled repeaters.

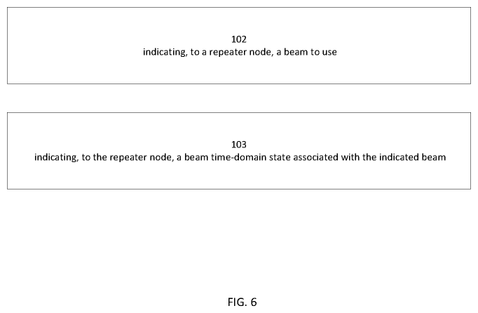

FIG. 6 is a flow chart that illustrates a method performed by a network node 502 for configuring periodic behavior of a repeater beam of a repeater node 506 according to an embodiments of the present invention. The repeater node 506 may be a network-controlled repeater node or a RIS for example. The network node 502 may be a gNB. The method comprises at 102 indicating, to the repeater node, a beam to use. The method further comprises at 104 indicating, to the repeater node, a beam time-domain state associated with the indicated beam. It will be appreciated that 102 and 104 may be performed simultaneously.

The method may comprise indicating the beam to use from among a set of repeater beams.

In some embodiments, indicating 102 the beam to use may comprise indicating the beam using Beam index/ID.

The indication of the beam to use may be conveyed to the repeater node in RRC signaling and/or MAC CE signaling.

According to an embodiment, the beam time-domain state indicates a time at which the repeater node should use the indicated beam.

The beam time-domain state may comprise: starting OFDM symbol in a slot, duration in number of OFDM symbols, slot number and/or slot periodicity.

According to embodiments, the beam time-domain state may be associated with a periodicity. The beam time-domain state may be semi-static.

The indication of the beam-time domain state associated with the indicated beam may be conveyed in RRC signaling. In an embodiment, the beam time-domain state may be

RRC configured in the repeater node as an RRC information element.

In an embodiment, the beam to use and the beam time-domain state associated with the beam to use are configured jointly by the network node.

The method may further comprise indicating, to the repeater node, a plurality of beams to use and indicating, to the repeater node, a plurality of associated beam time-domain states. In this embodiment, each beam time-domain state may be associated with a respective one of the plurality of beams to use.

The method may comprise indicating, to the repeater node, a beam to use and/or a beam time-domain state associated with the indicated beam based on repeater beam information.

The method may further comprise receiving a repeater beam arrangement report from a repeater node.

The method may further comprise using the indicated beam according to the indicated beam time-domain state.

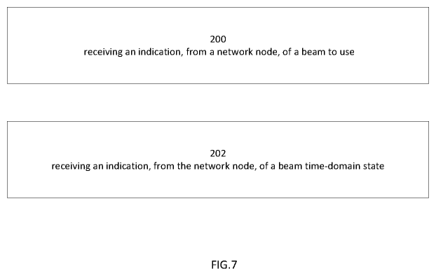

FIG. 7 is a flow chart that illustrates a method performed by a repeater node 506 according to embodiments of the present invention. As mentioned above, the repeater node may be, for example, a network-controlled repeater or a RIS. At 200, the method comprises receiving an indication, from a network node 502, of a beam to use. At 202, the method comprises receiving an indication, from a network node 502, of a beam time-domain state associated with the indicated beam.

The indication of a beam to use may be an indication of a beam to use from among a set of repeater beams.

In some embodiments, the indication of a beam to use may comprise Beam index/ID.

The indication of the beam to use may be received in RRC signaling and/or MAC CE signaling.

The beam time-domain state may comprise: Starting OFDM symbol in a slot, Duration in number of OFDM symbols, Slot number and/or Slot periodicity.

According to embodiments, the beam time-domain state is associated with a periodicity. The beam time-domain state may be semi-static.

The indication of the beam time-domain state associated with the indicated beam may be received in RRC signaling. In an embodiment, the beam time-domain state may be RRC configured as one RRC information element.

The beam to use and the beam time-domain state associated with the indicated beam may be configured jointly at the repeater node.

The method may further comprise receiving, from the network node, an indication of a plurality of beams to use and an indication of a plurality of associated beam time-domain states. In this embodiment, each of the beam time-domain states may be associated with a respective one of the plurality of beams.

The method may further comprise transmitting a repeater beam arrangement report to the network node.

As mentioned above, the repeater node 506 may be, for example, a network-controlled repeater.

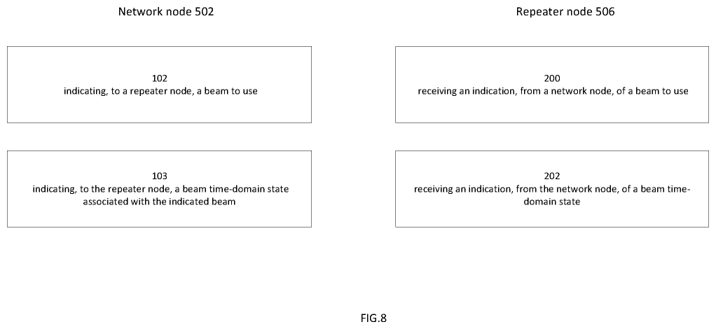

FIG. 8 illustrates a method for configuring periodic behavior of a repeater beam of repeater node in a network according to embodiments of the present invention. The method comprises at 102 a network node indicating, to the repeater node, a beam to use and at 103 indicating, to the repeater node, a beam time-domain state associated with the indicated beam. The method further comprises at 200 the repeater node receiving the indication, from the network node, of a beam to use and at 202 receiving, from the network node, a beam time-domain state associated with the indicated beam.

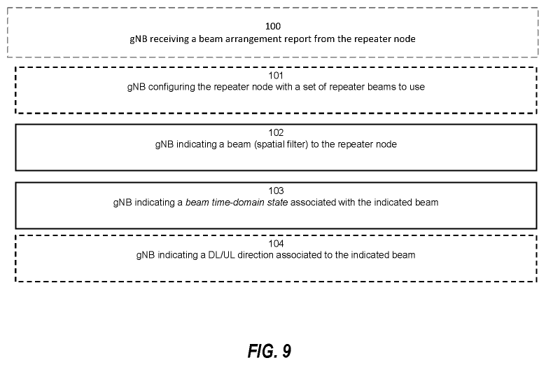

FIG. 9 is a flow chart that illustrates the operation of the gNB 502 of FIG. 5 in accordance with some examples. Note that optional steps are represented by dashed lines. The method enables the gNB 502 to configure periodic behavior of spatial filter configuration of the repeater node 506.

As illustrated in FIG. 9, in a first Step 100, the gNB 502 may receive a repeater beam arrangement report from the repeater node 506. The repeater beam arrangement report includes information that indicates one or more repeater beam capabilities of the repeater node 506 and beam information for each type of repeater beam, e.g., regarding one or more of the following:
Size of antenna plane (X-by-Y) and/or number of fundamental (FFT) beams (X-by-Y)
A beam hierarchy, for example beam constellation (horizontal X-axis by vertical Y-axis, or relative position to bore sight etc.) for beam hierarchy level, and or beam configuration for lower beam hierarchy level, e.g., a set of M by N beams for, say, every beam of the higher beam hierarchy.
Number of beams of each type of beam (for example different types of beams have different beamwidths). The number of beams can be reported as the number of vertical beams, and the number of horizontal beams (which will mean that the total number of beams of a certain type of beams would be equal to “number of horizontal beams”*“number of vertical beams”, assuming a rectangular DFT beam grid)
Beam direction relation between different beams for a beam type (adjacent vs non-adjacent beam direction)
Polarization of the beam
Maximum number of beams that the repeater node 506 can be configured with
Beam Switching Delay/Latency Information
Number of Repeater Beam Switches per Slot Information
Beam expansion capability, and associated beam expansion vectors, including possible limitations in the beam expansion capability.

The repeater beam arrangement report may be signaled from the repeater node 506 to the gNB 502 via signaling such as, e.g., RRC, MAC CE etc. Alternatively, the repeater beam arrangement report may be received indirectly from the repeater node 506, for example via an intermediate node. Regardless, the network node 502 obtains repeater beam information. Note that the “beam arrangement report” can consist of several different parts where each part can contain different information, as for example listed above.

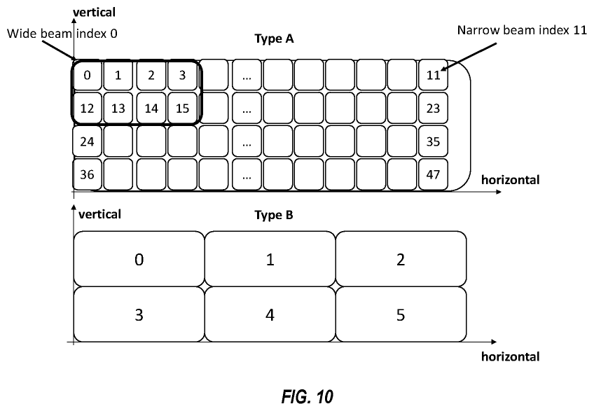

In one example, the repeater beams are indicated in the beam arrangement report using e.g., beam index, or beam ID, or beam index of a parent beam index in a beam hierarchy. As schematically illustrated in FIG. 10, in the beam arrangement report, the repeater node 506 informs the gNB 502 about its types of beams. In the illustrated example, there are two types of beams (i.e., Type A narrow beams and Type B wide beams), where there are 48 Type A narrow beams and 6 Type B wide beams. Thus, the beam arrangement report may inform the gNB 502 that the repeater node 506 has 48 Type A narrow beams and 6 Type B wide beams. The repeater node 506 can also explicitly indicate (e.g., in the beam arrangement report) which narrow beams are included in which wide beams. For example, looking at the example of FIG. 7, the repeater node 506 can explicitly indicate (e.g., in the beam arrangement report) that narrow beams 0,1,2,3,12,13,14,15, are confined in the wide beam idx_0 (as shown in the box of the narrow beam table in FIG. 10). This would be useful, for example, if hierarchal beam sweep procedures are used, where first the wide beams are evaluated, and then a narrow beam sweep is performed within the best reported wide beam (as described with P1 and P2 in Section 3.1 of the Introduction section above).

In another example, the repeater node 506 indicates (e.g., in the beam arrangement report) a capability of beam expansion together with its antenna array or plane properties, e.g., number of antenna elements in X and Y dimensions, or its fundamental (FFT) phased array beam properties, i.e., how many different narrow beams the repeater can form, in X and Y dimensions.

In an optional Step 101, the gNB 502 configures the repeater node 506 with a set of repeater beams to use. In one example embodiment, the maximum number of repeater beams to use is a fixed number (or included in the repeater beam arrangement report), e.g., to limit the signaling overhead. In another example embodiment, the maximum number of repeater beams to use can be determined by the gNB 502 and indicated to the repeater node 506. The gNB 502 may only configure the repeater node 506 to use a subset of reported repeater beams based on its needs or for interference management. In one embodiment, the gNB 502 determines the set of repeater beams to use based on its own beam control capability, e.g., gNB beam switching delay/latency information, or gNB beam types. In one embodiment, the gNB 502 determines the said set of repeater beams to use based on the directional relations between the repeater beams. In another embodiment, the gNB 502 determines the said set of repeater beams to use based on, e.g., network traffic conditions, or network interference levels etc.

If the repeater node 506 is capable of beam expansion per above, a shorter reference precoder can be configured for the repeater node 506 to use, and the repeater node 506 can itself design the appropriate longer precoder, thereby achieving a wider beam compared to phased array (FFT) precoder but with maintained output transmit power. The gNB 502 would know how many expanded precoders need to be configured and select a suitable starting precoder size based on that. For example, if 4 SSBs are to be used with the repeater node 506, the gNB 502 could then configure the repeater with 4 proto-beams with associated proto-precoders and the repeater would expand said precoders from precoders of size 4 up until the precoder covered all antenna elements of the repeater. Thereby a wider beam would be achieved without sacrificing transmission power. Alternatively, or additionally, the gNB 502 could indicate the initial proto-beam and associated proto-precoders by an index or indicate the proto-precoder size and the repeater would construct as many wide beams as possible from beam expansion. Furthermore, the gNB 502 could indicate the complex multiplier K (see Section 4 of the Introduction section above) to be used in the beam expansion. Narrower beams would be directly related to one of the wider beams, e.g., by phase relations, and could either be indexed in relation to the proto-beam or independently, provided a specified indexation order exists.

In one embodiment, the gNB 502 indicates the set of repeater beams to use based on the information in the repeater beam arrangement report using one or more of the following:
Repeater beam index/ID
Repeater beam index/ID+repeater beam type index/ID
Repeater beam polarization index/ID
A bitfield, where each bit in the bitfield is associated to a beam according to the repeater beam arrangement report
A bitfield per beam type, where each bit in the bitfield is associate with a beam of that beam type according to the repeater beam arrangement report
Maximum number of beams that the repeater node can be configured with
Initial proto-beam(s) and/or proto-beam antenna size(s) and/or proto-beam indices

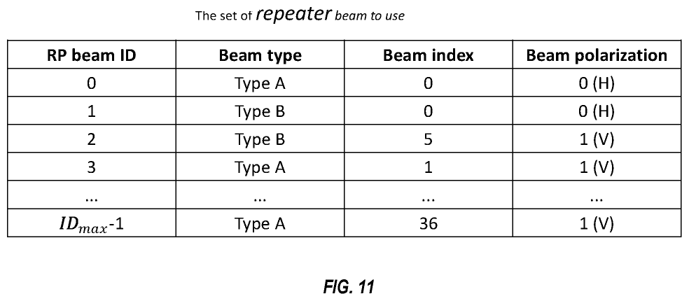

In one example, the set of repeater beams to use can be provided to the repeater node 506 in table form, as example of which is illustrated in FIG. 11. The table contains a set of up to IDₘₐₓ (in the example of FIG. 11) repeater beams, where each is assigned with a repeater (RP) beam ID and described with a beam type (e.g., narrow/wide, ref. FIG. 10) and a beam index (e.g., 0-47, ref. FIG. 7) with respect to the beam type, and a polarization index (0 indicating H-polarization, 1 indicating V-polarization, in the example of FIG. 11).

In one embodiment, the set of repeater beam to use is conveyed in e.g., RRC, MAC-CE signaling

In Steps 102 and 103, during operation, in this example, the gNB 502 controls the time domain usage of repeater beams by indicating to the repeater node 506 a beam from the configured set of repeater beams to use (Step 102) and its associated beam time-domain state (Step 103). Note that since Step 101 is optional, in one alternative embodiment, the gNB 502 controls the time domain usage of repeater beams by indicating to the repeater node 506 a beam from a set of repeater beams reported in the beam arrangement report. In one embodiment, the beam indication of Step 102 can use one or more of
Repeater beam index/ID
Repeater beam index/ID+repeater beam type index/ID
Repeater beam polarization index/ID
A bitfield, where each bit in the bitfield is associated to a beam according to the repeater beam arrangement report
A bitfield per beam type, where each bit in the bitfield is associated with a beam of that beam type according to the repeater beam arrangement report
Repeater forwarding (FWD) OFF configuration, in which case the repeater access side is not expected to be operable and only the Repeater Modem module is practically active. In one embodiment, the OFF configuration could be or result from a certain beam index outside the range of actual beam indices.
Repeater INACTIVE or IDLE, in which case the whole repeater becomes inactivated at various levels. This could be, e.g., in a shopping mall outside opening hours.
Beam amplification level, i.e., which amplification should be applied for the beam.

The repeater beam indication may be conveyed in RRC signaling, and/or MAC-CE signaling.

In a Step 103, the gNB indicates a beam time-domain state associated to the indicated beam from Step 102. In one embodiment, each beam time-domain state is associated to one indicated repeater beam. In another embodiment, multiple beam time-domain states can be associated to one indicted repeater beam.

In one embodiment, the beam time-domain state associated to an indicated repeater beam is based on the repeater beam arrangement report in Step 101. In one example embodiment, the gap period for a beam switch between two beams is based on the Repeater Beam Switching Delay/Latency Information. In another example embodiment, the maximum number of beam switches configured for the repeater node in one slot is based on the Number of Repeater Beam Switches per Slot Information, indicated in Step 101.

In one embodiment, the configuration of the beam time-domain state includes one or more of
Starting OFDM symbol in a slot
Ending OFDM symbol in a slot
Duration in number of OFDM symbols in a slot
System frame number
Sub-frame number
Slot number
Slot periodicity
Duration in number of slots
Datetime instance such as hour, minute, second etc.

In one embodiment, the beam time-domain state is semi-static and associated with a periodicity which is recurring with periodic signals/channels. In one example embodiment, the periodicity of a beam time-domain state can be same as, or shorter than, or longer than the periodicity of the TDD pattern, e.g., according to the RRC parameter TDD-UL-DL-configurationCommon.

In one embodiment, the beam time-domain state is associated to different types of periodic cell common signals/channels, e.g., SSB, SIBs, TRS, Coreset 0, paging, PRACH etc.

In another embodiment, the beam time-domain state is associated to periodic reference signals used for UE measurement in radio link monitoring, or handover etc. The reference signals can be CSI-RS, SRS etc.

In one embodiment, the beam time-domain states have priorities, for example periodic signals/channels are prioritized over aperiodic signals/channels.

In one embodiment, the beam indication and the beam time-domain state can be configured jointly by the gNB 502.

In one example embodiment, the beam time-domain state and the associated beam indication are only configured for the operations of the Repeater Module. In another example embodiment, the operations of the Controller Module and the Repeater Module are configured with joint beam time-domain state and the associated beam indication. Alternatively, the operations of the Controller Module and the Repeater Module are configured with separate beam time-domain state and the associated beam indication.

It should be understood that what above is described as a time domain configuration per beam may just as well be described as a beam configuration per time element or per time interval.

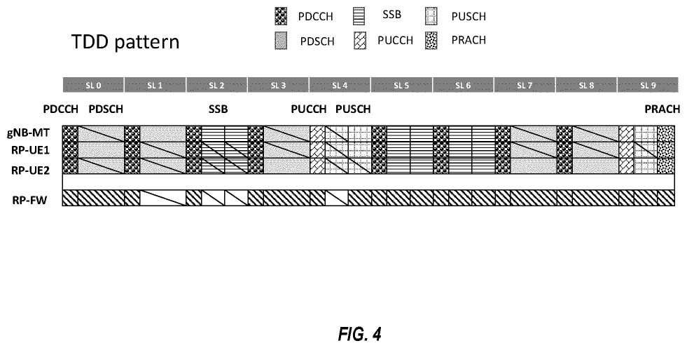

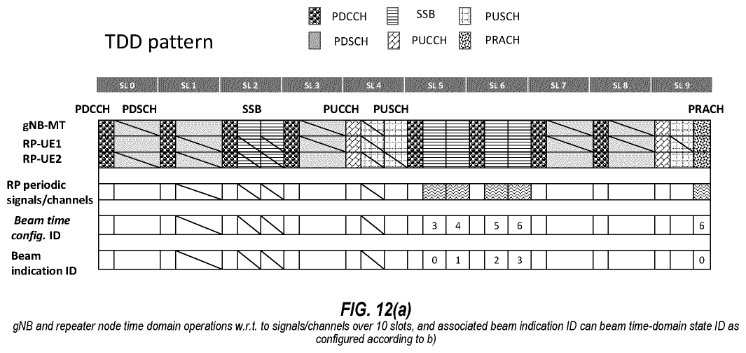

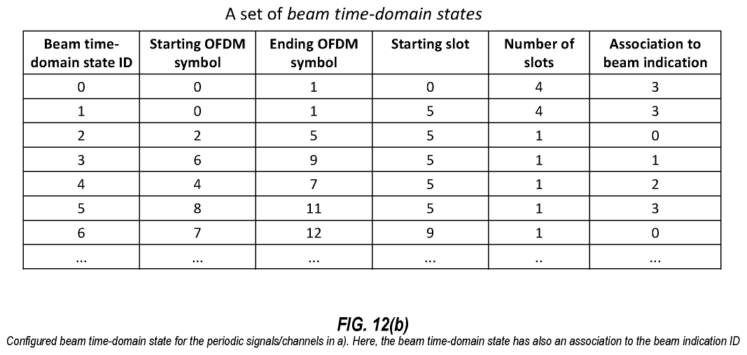

FIG. 12(a) and FIG. 12(b) show one example to illustrate gNB and repeater node operations with respect to signals/channels in 10 slots, and the configured beam indication and beam time-domain state. Similar to FIG. 4, FIG. 12(a) shows time domain operations with respect to different signals/channels (PDCCH/PDSCH/PUSCH/PUCCH/SSB/PRACH) at the gNB 502 and the repeater node 506 over 10 consecutive slots, when serving UE1 (e.g., UE 504-1) and UE2 (e.g., UE 504-2), respectively, in accordance with one example embodiment of the present disclosure. The diagonal line indicates the time resource is not used in communication, e.g., between gNB 502 and repeater node 506, or between the repeater node 506 and UE1 504-1 etc. The zigzag pattern represents the time resource where the repeater node is configured with periodic signals/channels, e.g., SSB and PRACH. An example of configuration of the associated beam time-domain states is provided in FIG. 9(b), based on starting and ending OFDM symbols, respectively, starting slot, number of slots and association to the beam indication, referred to the set of repeater beams to use, see, e.g., FIG. 8. In some cases, one type of signal/channels in one slot is associated to one beam time-domain state (see beam time-domain states 2-6). In other cases, one beam time-domain state can apply to symbols in multiple slots, see beam time-domain states 0 and 1.

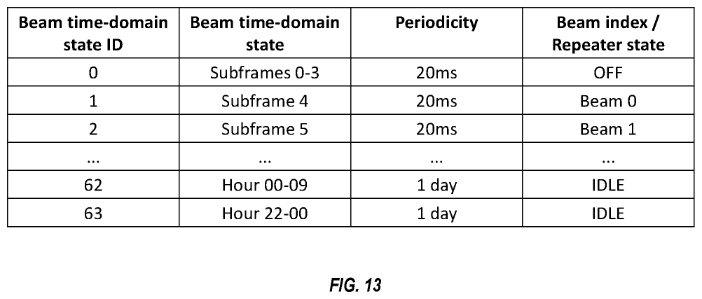

FIG. 13 gives another example to illustrate a joint indication of beam time-domain state and repeater beam and/or repeater state indication.

In one embodiment, the indication of the beam time-domain state is conveyed in, e.g., RRC, MAC-CE, etc. In one example embodiment, each beam time-domain state is configured to a repeater node in one RRC information element. In yet another example embodiment, each beam time-domain state RRC information element includes an implicit mapping to one of the indicated repeater beams. In yet another example embodiment, each beam time-domain state includes an explicit mapping to one of the beams in the beam arrangement report. In yet another detailed embodiment, each beam time-domain state includes an explicit mapping to one of the beams in the set of repeater beams to use.

In one embodiment, the gNB 502 can update beam time-domain state associated to an indicated beam in selection of one or more of:
the set of repeater beams to use is updated
TDD pattern is reconfigured
certain cell common signals/channels are reconfigured
certain periodic reference signals are reconfigured.

In an optional Step 104, the gNB 502 may indicate to the repeater node 506 about the DL/UL direction associated to an indicated beam. In one example, the DL/UL direction can be dynamically provided by, e.g., DCIs, or those upper layer parameters.

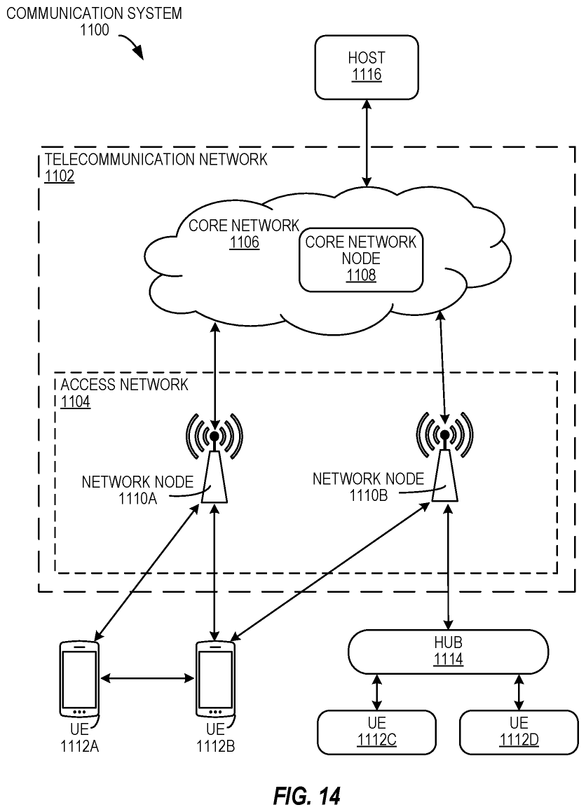

FIG. 14 shows an example of a communication system 1100 in accordance with some embodiments.

In the example, the communication system 1100 includes a telecommunication network 1102 that includes an access network 1104, such as a Radio Access Network (RAN), and a core network 1106, which includes one or more core network nodes 1108. The access network 1104 includes one or more access network nodes, such as network nodes 1110A and 1110B (one or more of which may be generally referred to as network nodes 1110), or any other similar Third Generation Partnership Project (3GPP) access node or non-3GPP Access Point (AP). The network nodes 1110 facilitate direct or indirect connection of User Equipment (UE), such as by connecting UEs 1112A, 1112B, 1112C, and 1112D (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 14 enables connectivity between the UEs, network nodes, and hosts. In that sense, the communication system 1100 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1102 is a cellular network that implements 3GPP standardized features. Accordingly, the telecommunication network 1102 may support network slicing to provide different logical networks to different devices that are connected to the telecommunication network 1102. For example, the telecommunication network 1102 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1114 communicates with the access network 1104 to facilitate indirect communication between one or more UEs (e.g., UE 1112C and/or 1112D) and network nodes (e.g., network node 1110B). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a Virtual Reality (VR) headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110B. The hub 1114 may also allow for a different communication scheme and/or schedule between the hub 1114 and UEs (e.g., UE 1112C and/or 1112D), and between the hub 1114 and the core network 1106. In other examples, the hub 1114 is connected to the core network 1106 and/or one or more UEs via a wired connection. Moreover, the hub 1114 may be configured to connect to a Machine-to-Machine (M2M) service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110B. In other embodiments, the hub 1114 may be a non-dedicated hub—that is, a device which is capable of operating to route communications between the UEs and the network node 1110B, but which is additionally capable of operating as a communication start and/or end point for certain data channels.

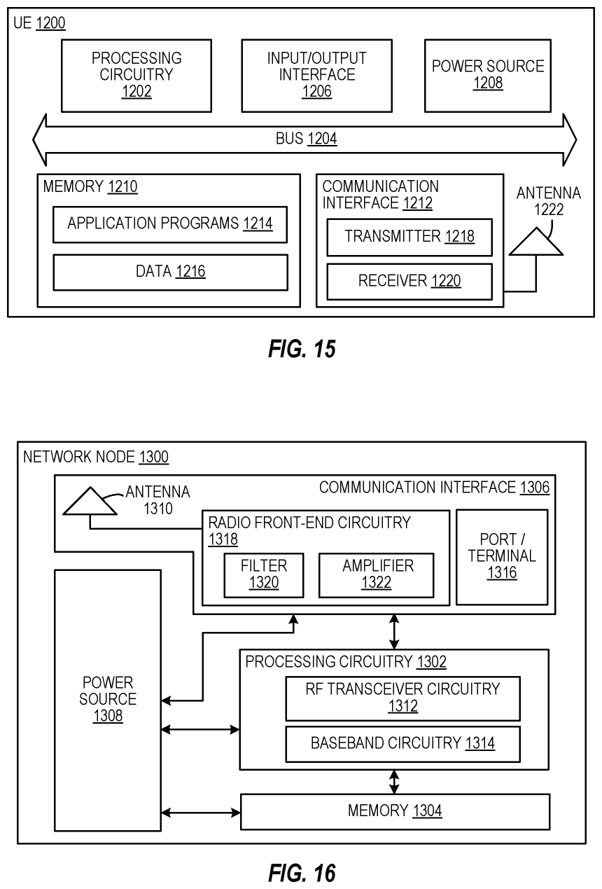

FIG. 15 shows a UE 1200 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, memory 1210, a communication interface 1212, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1202 may include multiple Central Processing Units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging the power source 1208. Power circuitry may perform any formatting, converting, or other modification to the power from the power source 1208 to make the power suitable for the respective components of the UE 1200 to which power is supplied.

The memory 1210 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1210 may allow the UE 1200 to access instructions, application programs, and the like stored on transitory or non-transitory memory media, to off-load data, or to upload data. An article of manufacture, such as one utilizing a communication system, may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., the antenna 1222) and may share circuit components, software, or firmware, or alternatively be implemented separately.

In the illustrated embodiment, communication functions of the communication interface 1212 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1212, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 16 shows a network node 1300 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes processing circuitry 1302, memory 1304, a communication interface 1306, and a power source 1308. The network node 1300 may be composed of multiple physically separate components (e.g., a Node B component and an RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1300 may be configured to support multiple RATs. In such embodiments, some components may be duplicated (e.g., separate memory 1304 for different RATs) and some components may be reused (e.g., an antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1300.

The processing circuitry 1302 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1300 components, such as the memory 1304, to provide network node 1300 functionality.

In some embodiments, the processing circuitry 1302 includes a System on a Chip (SOC). In some embodiments, the processing circuitry 1302 includes one or more of Radio Frequency (RF) transceiver circuitry 1312 and baseband processing circuitry 1314. In some embodiments, the RF transceiver circuitry 1312 and the baseband processing circuitry 1314 may be on separate chips (or sets of chips), boards, or units, such as radio units and digital units. In alternative embodiments, part or all of the RF transceiver circuitry 1312 and the baseband processing circuitry 1314 may be on the same chip or set of chips, boards, or units.

The memory 1304 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and the memory 1304 are integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. The radio front-end circuitry 1318 comprises filters 1320 and amplifiers 1322. The radio front-end circuitry 1318 may be connected to the antenna 1310 and the processing circuitry 1302. The radio front-end circuitry 1318 may be configured to condition signals communicated between the antenna 1310 and the processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of the filters 1320 and/or the amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface 1306 may comprise different components and/or different combinations of components.

In certain alternative embodiments, the network node 1300 does not include separate radio front-end circuitry 1318; instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes the one or more ports or terminals 1316, the radio front-end circuitry 1318, and the RF transceiver circuitry 1312 as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, the communication interface 1306, and/or the processing circuitry 1302 may be configured to perform any receiving operations and/or certain obtaining operations described herein as being performed by the network node 1300. Any information, data, and/or signals may be received from a UE, another network node, and/or any other network equipment. Similarly, the antenna 1310, the communication interface 1306, and/or the processing circuitry 1302 may be configured to perform any transmitting operations described herein as being performed by the network node 1300. Any information, data, and/or signals may be transmitted to a UE, another network node, and/or any other network equipment.

The power source 1308 provides power to the various components of the network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid or an electricity outlet) via input circuitry or an interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 16 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

According to embodiments, the network node 1300 may configured to perform any of the methods described above which are performed by a network node 502.

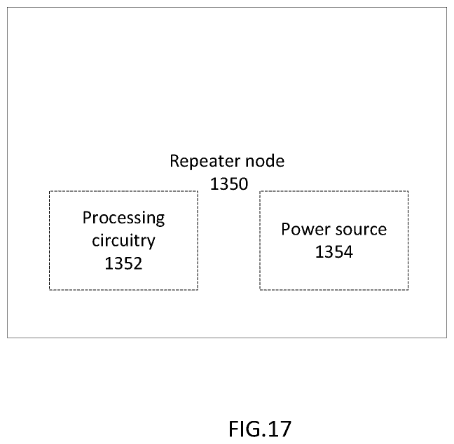

FIG. 17 is a block diagram of a repeater node 506, 1350 in accordance with some embodiments. The repeater node 1350 may comprise processing circuitry 1352 and a power source 1354. The repeater node 1350, 506 may be configured to perform any of the methods described above as performed by a repeater node.

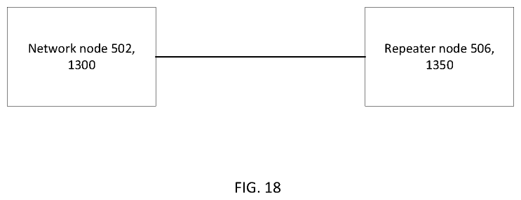

FIG. 18 is an illustration of a system comprising a network node 1300, 502 and a repeater node 1350, 506.

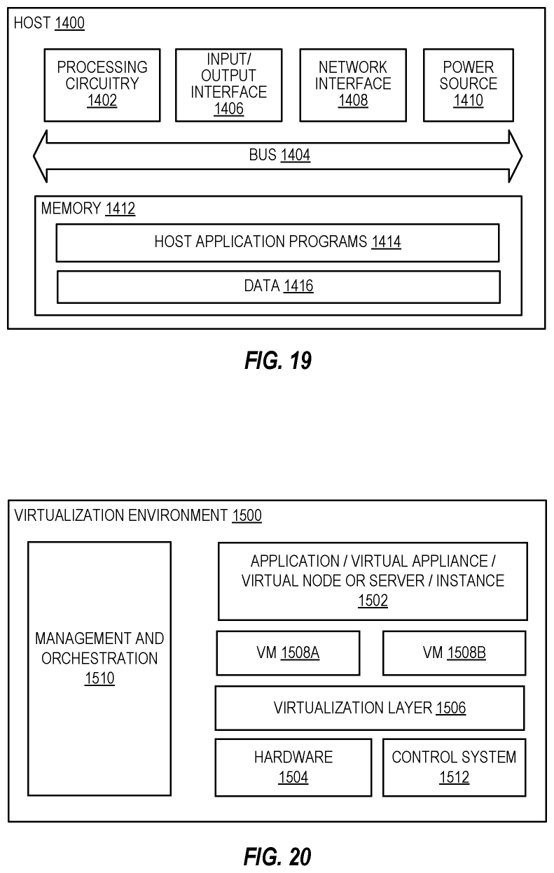

FIG. 19 is a block diagram of a host 1400, which may be an embodiment of the host 1116 of FIG. 14, in accordance with various aspects described herein. As used herein, the host 1400 may be or comprise various combinations of hardware and/or software including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and memory 1412. Other components may be included in other embodiments. Features of these components may be substantially similar to those described with respect to the devices of previous figures, such as FIGS. 15 and 16, such that the descriptions thereof are generally applicable to the corresponding components of the host 1400.

The memory 1412 may include one or more computer programs including one or more host application programs 1414 and data 1416, which may include user data, e.g. data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for Over-The-Top (OTT) services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 20 is a block diagram illustrating a virtualization environment 1500 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or VM Monitors (VMMs)), provide VMs 1508A and 1508B (one or more of which may be generally referred to as VMs 1508), and/or perform any of the functions, features, and/or benefits described in relation with some embodiments described herein. The virtualization layer 1506 may present a virtual operating platform that appears like networking hardware to the VMs 1508.

The VMs 1508 comprise virtual processing, virtual memory, virtual networking, or interface and virtual storage, and may be run by a corresponding virtualization layer 1506. Different embodiments of the instance of a virtual appliance 1502 may be implemented on one or more of the VMs 1508, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1508 may be a software implementation of a physical machine that runs programs as if they were executing on a physical, non-virtualized machine. Each of the VMs 1508, and that part of the hardware 1504 that executes that VM, be it hardware dedicated to that VM and/or hardware shared by that VM with others of the VMs 1508, forms separate virtual network elements. Still in the context of NFV, a virtual network function is responsible for handling specific network functions that run in one or more VMs 1508 on top of the hardware 1504 and corresponds to the application 1502.

The hardware 1504 may be implemented in a standalone network node with generic or specific components. The hardware 1504 may implement some functions via virtualization. Alternatively, the hardware 1504 may be part of a larger cluster of hardware (e.g., such as in a data center or CPE) where many hardware nodes work together and are managed via management and orchestration 1510, which, among others, oversees lifecycle management of the applications 1502. In some embodiments, the hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1512 which may alternatively be used for communication between hardware nodes and radio units.

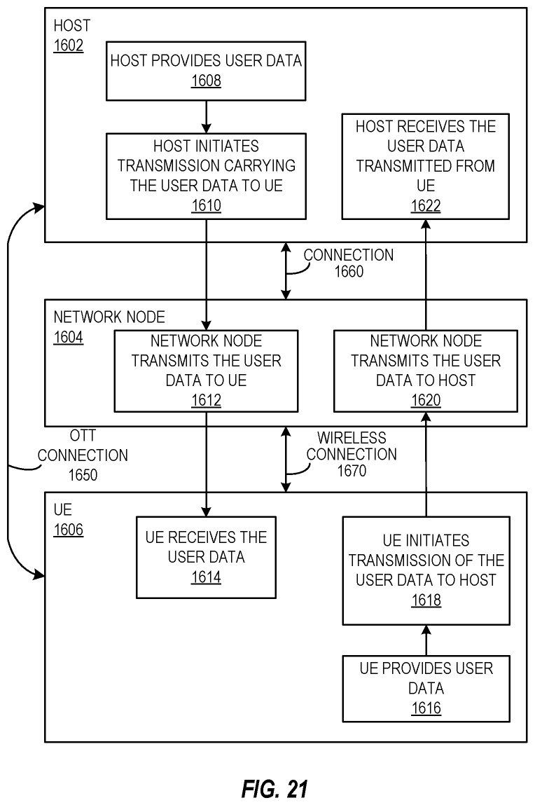

FIG. 21 shows a communication diagram of a host 1602 communicating via a network node 1604 with a UE 1606 over a partially wireless connection in accordance with some embodiments. Example implementations, in accordance with various embodiments, of the UE (such as the UE 1112A of FIG. 14 and/or the UE 1200 of FIG. 15), the network node (such as the network node 1110A of FIG. 14 and/or the network node 1300 of FIG. 16), and the host (such as the host 1116 of FIG. 14 and/or the host 1400 of FIG. 18) discussed in the preceding paragraphs will now be described with reference to FIG. 20.

Like the host 1400, embodiments of the host 1602 include hardware, such as a communication interface, processing circuitry, and memory. The host 1602 also includes software, which is stored in or is accessible by the host 1602 and executable by the processing circuitry. The software includes a host application that may be operable to provide a service to a remote user, such as the UE 1606 connecting via an OTT connection 1650 extending between the UE 1606 and the host 1602. In providing the service to the remote user, a host application may provide user data which is transmitted using the OTT connection 1650.

The network node 1604 includes hardware enabling it to communicate with the host 1602 and the UE 1606 via a connection 1660. The connection 1660 may be direct or pass through a core network (like the core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by the UE 1606 and executable by the UE's processing circuitry. The software includes a client application, such as a web browser or operator-specific “app” that may be operable to provide a service to a human or non-human user via the UE 1606 with the support of the host 1602. In the host 1602, an executing host application may communicate with the executing client application via the OTT connection 1650 terminating at the UE 1606 and the host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via the connection 1660 between the host 1602 and the network node 1604 and via a wireless connection 1670 between the network node 1604 and the UE 1606 to provide the connection between the host 1602 and the UE 1606. The connection 1660 and the wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604 in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR, or AR which it can broadcast, multicast, or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1650 between the host 1602 and the UE 1606 in response to variations in the measurement results. The measurement procedure and/or the network functionality for reconfiguring the OTT connection 1650 may be implemented in software and hardware of the host 1602 and/or the UE 1606. In some embodiments, sensors (not shown) may be deployed in or in association with other devices through which the OTT connection 1650 passes; the sensors may participate in the measurement procedure by supplying values of the monitored quantities exemplified above, or by supplying values of other physical quantities from which software may compute or estimate the monitored quantities. The reconfiguring of the OTT connection 1650 may include message format, retransmission settings, preferred routing, etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency, and the like by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some embodiments may be defined as follows:

### Group B Embodiments

1. A method performed by a network node (502) in a wireless network for configuring periodic behavior of spatial filter of a repeater node (506), the method comprising:
   receiving (100) a repeater beam arrangement report from a repeater node (506);
   indicating (102), to the repeater node (506), a beam (i.e., spatial filter) to use; and
   indicating (103), to the repeater node (506), a beam time-domain state associated with the indicated beam.
2. The method of embodiment 1 and where the repeater beam arrangement report received from the repeater node (506) comprises:
   a) Number of beam types/hierarchy levels,
   b) Number of beams for a given beam type/hierarchy level,
   c) Beam constellation (e.g., horizontal by X-axis and/or vertical by Y-axis, or relative position to bore sight etc.) for beam type/hierarchy level,
   d) Relation of beams to beams of a different beam type/hierarchy level,
   e) Polarization of the beam,
   f) Beam switching delay/latency information,
   g) Number of repeater beam switches per slot information,
   h) Beam expansion capability, and associated beam expansion vectors, including possible limitations in the beam expansion capability, or
   i) a combination of any two or more of a)-h).
3. The method of embodiment 1 or 2 further comprising configuring (101) the repeater node (506) with a set of repeater beams to use.
4. The method of embodiment 3 wherein the set of repeater beams to use is determined based on:
   a) network node (502) beam capability,
   b) repeater beam direction relation,
   c) configured signals and channels,
   d) network traffic condition,
   e) interference level at the network node,
   f) interference level at the repeater node, or
   g) a combination of any two or more of a)-f).
5. The method of embodiment 3 or 4 wherein the set of repeater beams to use is restricted to a fixed maximum number of beams.
6. The method of any of embodiments 3 to 5 wherein when configuring (101) the repeater node (506) with the set of repeater beams to use, the set of repeater beams to use is indicated using information based on the beam arrangement report.
7. The method of any of embodiments 3 to 5 wherein when configuring (101) the repeater node (506) with the set of repeater beams to use, the set of repeater beams to use is indicated using information based on the beam arrangement report, the information based on the beam arrangement report comprising:
   a) Beam index/ID,
   b) Beam index/ID+beam type index/ID,
   c) Polarization index/ID,
   d) A bitfield, where each bit in the bitfield is associated with a beam according to the repeater beam arrangement report,
   e) A bitfield per beam type, where each bit in the bitfield is associated with a beam of that beam type according to the repeater beam arrangement report,
   f) Beam expansion factor+beam index, or
   g) a combination of any two or more of a)-f).
8. The method of any of embodiments 3 to 7 wherein configuring (101) the repeater node (506) with the set of repeater beams to use comprises configuring (step 101) the repeater node (506) with the set of repeater beams to use via RRC or MAC CE signaling.
9. The method of any of embodiments 3 to 8 wherein indicating (102), to the repeater node (506), the beam to use comprises indicating (102) the beam to use from among the set of repeater beams that the repeater node (506) is configured to use.
10. The method of embodiment 1 or 2 wherein indicating (102), to the repeater node (506), the beam to use comprises indicating (102) the beam to use from among a set of repeater beams reported in the repeater beam arrangement report.
11. The method of embodiment 9 or 10 wherein indicating (102) the beam to use comprises indicating the repeater beam using:
   a) Beam index/ID,
   b) Beam index/ID+beam type index/ID,
   c) Polarization index/ID,
   d) A bitfield, where each bit in the bitfield is associated with a beam according to the repeater beam arrangement report,
   e) A bitfield per beam type, where each bit in the bitfield is associated with a beam of that beam type according to the repeater beam arrangement report,
   f) Beam expansion factor, or
   g) a combination of any two or more of a)-f).
12. The method of any of embodiments 9 to 11 wherein the beam indication is conveyed in RRC signaling and/or MAC CE signaling.
13. The method of any of embodiments 1 to 12 wherein the beam time-domain state associated to the indicated beam is based on the beam arrangement report.
14. The method of embodiment 13 wherein the beam arrangement report comprises beam switch delay or latency information, and a gap period for switching beams is based on the beam switching delay or latency information.
15. The method of embodiment 14 wherein the beam arrangement report comprises a number of repeater beam switches per slot information, and/or a maximum number of beam switches configured for the repeater node (506) in one slot that is based on the number of repeater beam switches per slot information comprised in the repeater beam arrangement report.
16. The method of any of embodiments 13 to 15 wherein the beam time-domain state comprises:
   a) Starting OFDM symbol in a slot,
   b) Ending OFDM symbol in a slot,
   c) Duration in number of OFDM symbols,
   d) System frame number,
   e) Sub-frame number,
   f) Slot number,
   g) Slot periodicity,
   h) Duration in number of Slots,
   i) Repeater amplification level,
   j) Datetime instance, e.g., hour, minute, second etc., or
   k) a combination of any two or more of a)-j).
17. The method of any of embodiments 13 to 16 wherein indicating (103), to the repeater node (506), the beam time-domain state associated with the indicated beam comprises indicating (103), to the repeater node (506), the beam time-domain state associated with the indicated beam via RRC signaling and/or MAC-CE signaling
18. The method of any of embodiments 13 to 17 wherein each beam time-domain state is RRC configured in the repeater node (506) as an RRC information element.
19. The method of any of embodiments 13 to 18 wherein each beam time-domain state is associated with one indicated repeater beam.
20. The method of any of embodiments 13 to 19 wherein each beam time-domain state RRC information element includes an implicit mapping to one of the indicated repeater beams.
21. The method of any of embodiments 13 to 20 wherein each beam time-domain state includes an explicit mapping to one of a plurality of beams in the beam arrangement report.
22. The method of any of embodiments 1 to 21 wherein the beam time-domain state is associated to a set of slots/symbols configured to one or more cell-common signals and/or one or more cell-common channels.
23. The method of embodiment 22 wherein the one or more cell-common signals and/or the one or more cell-common channels comprise:
   a) SSB,
   b) TRS,
   c) SIBs,
   d) Coreset 0,
   e) Paging,
   f) PRACH, or
   g) a combination of any two or more of a)-f).
24. The method of any of embodiments 1 to 23 wherein the beam time-domain state is associated to a set of slots/symbols configured to one or more periodic reference signals.
25. The method of embodiment 24 wherein the one or more periodic reference signals comprise CSI-RS and/or SRS.
26. The method of any of embodiments 1 to 25 wherein the beam time-domain state is semi-static and associated with a periodicity.
27. The method of any of embodiments 1 to 26 wherein the beam time-domain state is recurring with periodic signals or periodic channels.
28. The method of any of embodiments 1 to 27 wherein the time domain state has a priority among one or more additional time domain states.
29. The method of any of embodiments 1 to 28 further comprising indicating (104), to the repeater node (506) a DL/UL direction information associated with the indicated beam.
30. The method of any of embodiments 1 to 29 wherein the repeater node (506) is a network-controlled repeater, an Intelligent Reflecting Surface (IRS), Reconfigurable intelligent surface (RIS), or a node with similar functionalities.
31. The method of any of the previous embodiments, further comprising:
   obtaining user data; and
   forwarding the user data to a host or a user equipment.

### Group C Embodiments

32. A network node comprising:
   processing circuitry configured to perform any of the steps of any of the Group B embodiments;
   power supply circuitry configured to supply power to the processing circuitry.
33. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
34. The host of the previous embodiment, wherein:
   the processing circuitry of the host is configured to execute a host application that provides the user data; and
   the UE comprises processing circuitry configured to execute a client application associated with the host application to receive the transmission of user data from the host.
35. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
36. The method of the previous embodiment, further comprising, at the network node, transmitting the user data provided by the host for the UE.
37. The method of any of the previous 2 embodiments, wherein the user data is provided at the host by executing a host application that interacts with a client application executing on the UE, the client application being associated with the host application.
38. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
39. The communication system of the previous embodiment, further comprising:
   the network node; and/or
   the user equipment.
40. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
41. The host of the previous 2 embodiments, wherein:
   the processing circuitry of the host is configured to execute a host application, thereby providing the user data; and
   the host application is configured to interact with a client application executing on the UE, the client application being associated with the host application.
42. The host of the any of the previous 2 embodiments, wherein the initiating receipt of the user data comprises requesting the user data.
43. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
44. The method of the previous embodiment, further comprising at the network node, transmitting the received user data to the host.

1. A method performed by a network node in a wireless network for configuring periodic behavior of a repeater beam of a repeater node, the method comprising:
indicating, to the repeater node, a beam to use; and
indicating, to the repeater node, a beam time-domain state associated with the indicated beam.

2. The method of claim 1, wherein indicating, to the repeater node, the beam to use comprises indicating the beam using Beam index/ID.

3. The method of claim 1, wherein the indication of the beam to use is conveyed in Radio Resource Control, RRC, signaling and/or Medium Access Control Control Element, MAC CE, signaling.

4. The method of claim 1, wherein the beam time-domain state comprises:
a) Starting Orthogonal Frequency Division Multiplexing, OFDM, symbol in a slot,
b) Duration in number of OFDM symbols,
c) Slot number and/or
d) Slot periodicity.

5. The method of claim 1, wherein the indication of the beam time-domain state associated with the indicated beam is conveyed in RRC signaling.

6. The method of claim 1, wherein the beam time-domain state is RRC configured in the repeater node as an RRC information element.

7. The method of claim 1, wherein the beam time-domain state is associated with a periodicity.

8. The method of claim 1, wherein the beam time-domain state is semi-static.

9. The method of claim 1, wherein the beam to use and the beam time-domain state associated with the indicated beam are configured jointly by the network node.

10. The method of claim 1, comprising indicating, to the repeater node, a plurality of beams to use and indicating, to the repeater node, a plurality of associated beam time-domain states, wherein each beam time-domain state is associated with a respective one of the plurality of beams to use.

11. The method of claim 1, wherein indicating, to the repeater node, a beam to use comprises indicating, to the repeater node, a beam to use from among a set of repeater beams.

12. The method of claim 1, comprising indicating, to the repeater node, a beam to use and/or a beam time-domain state associated with the indicated beam based on repeater beam information.

13. The method of claim 1, further comprising receiving a repeater beam arrangement report from a repeater node.

14. A method performed by a repeater node in a wireless network for configuring periodic behavior of a repeater beam of the repeater node, the method comprising:
receiving an indication, from a network node, of a beam to use; and
receiving an indication, from the network node, of a beam time-domain state associated with the indicated beam.

15. The method of claim 14, wherein the indication of a beam to use comprises Beam index/ID.

16. The method of claim 14, wherein the indication of the beam to use is received in RRC signaling and/or MAC CE signaling.

17. The method of claim 14, wherein the beam time-domain state comprises:
e) Starting OFDM symbol in a slot,
f) Duration in number of OFDM symbols,
g) Slot number and/or
h) Slot periodicity.

18. The method of claim 14, wherein the indication of the beam time-domain state associated with the indicated beam is received in RRC signaling.

19-27. (canceled)

28. A network node for a wireless network for configuring periodic behavior of a repeater beam of a repeater node, the network node comprising:
processing circuitry configured to cause the network node to:
indicate, to the repeater node, a beam to use; and
indicate, to the repeater node, a beam time-domain state associated with the indicated beam; and
power supply circuitry configured to supply power to the processing circuitry.

29. A repeater node for a wireless network comprising:
processing circuitry configured to cause the repeater node to:
receive an indication, from a network node, of a beam to use; and
receive an indication, from the network node, of a beam time-domain state associated with the indicated beam.

30. (canceled)

31. (canceled)
